(19) United States
(12) Patent Application Publication
(10) Pub. No.: US 2026/0133312 A1
(43) Pub. Date: May 14, 2026

(54) RADAR-BASED GUNSHOT DETECTION

(71) Applicant: WavePoint Solutions LLC, Kensington, CT (US)

(72) Inventors: Nathaniel Wilcox, Arlington, VA (US); James Wissman, Laurel, MD (US); John Morton, Ellicott City, MD (US); R. Scott Poteet, Whiteford, MD (US); Shawn Sweep, Westminister, MD (US); Michael Pascale, Columbia, MD (US); James Morton, Ellicott City, MD (US)

(21) Appl. No.: 19/382,399

(22) Filed: Nov. 7, 2025

Related U.S. Application Data
(60) Provisional application No. 63/718,148, filed on Nov. 8, 2024.

(51) Int. Cl. G01S 13/88; F41H 11/00; G01S 13/58

(52) U.S. Cl. CPC G01S 13/88; F41H 11/00; G01S 13/58

(57) ABSTRACT

A gunshot detection system includes a housing, a radar transmitter connected to the housing, a plurality of radar antennas connected to the housing, and a controller connected to the housing. The controller is operatively connected to the radar transmitter to cause the radar transmitter to generate radar transmission signals. The controller is configured to receive and record reflection data from the plurality of radar antennas. The controller is configured to determine a gunshot origination location of each bullet moving through a detection zone based on the reflection data.

### CROSS REFERENCE TO RELATED APPLICATION

The present application claims priority to U.S. Provisional Patent Application No. 63/718,148, filed Nov. 8, 2024, which is hereby incorporated by reference in its entirety.

### TECHNICAL FIELD

The present disclosure relates to gunshot detection systems and, more particularly, radar-based gunshot detection systems that are configured to determine gunshot event information, such as gunshot origination location (latitude, longitude, and elevation).

### BACKGROUND

Gunshot detection systems and methods are useful for a variety of military and police enforcement applications. Conventional gunshot detection systems use an array of acoustic microphones and/or acoustic sensors configured to detect the acoustic signature of a gunshot for determining gunshot origination location.

Some gunshot detection systems and methods are not completely automated in the sense that acoustic detection data generated by a computer-implemented systems is first sent to a human operator for review and approval before the acoustic event is confirmed as a gunshot and a gunshot origination location area is determined. Due to the human review requirement, this process generally lasts one to five minutes before police enforcement are provided with a gunshot event indication and a gunshot origination location area.

Moreover, there are other drawbacks beyond the poor response times of acoustic-based gunshot detection systems. For example, acoustic-based systems often generate false alarms due to detection of acoustic signatures not associated with a gunshot, such as a car backfiring. The commercial marketplace has tried to address the shortcoming with a centralized database of gunshot recordings and the sound profiles and other events that can potentially cause false alarms for comparison with artificial intelligence algorithms and even a human-in-the-loop with marginal success. Additionally, the gunshot origination location area provided by an acoustic-based system is typically undesirably large due to inherent deficiencies in an acoustic-based system. Law enforcement or other responders to a gunshot detection event from an acoustic-based system may waste precious time and resources searching an unacceptably large area for victims, perpetrators, shell casings or other evidence of a crime.

### SUMMARY

The present disclosure advantageously provides radar-based gunshot detection systems and methods that overcome the aforementioned deficiencies of acoustic-based systems. While radar-based detection systems have long been used to detect relatively large aerial objects, such as aircraft or missiles, no one in the industry has implemented a radar-based gunshot detection system for tracking bullet projectiles in real-time to determine a gunshot origination location. Bullet projectiles have a radar detectable cross-section of −45 dBsm that is orders of magnitude smaller than aircraft or missiles (stealth aircraft: −10 dBsm, missile: −10 dBsm, fighter aircraft: 7 dBsm, cargo aircraft: 20 dBsm). The present disclosure provides novel and inventive apparatuses and methods for effectively tracking bullet projectiles using radar-based equipment.

The benefits of the radar-based gunshot detection systems and method of the present disclosure are numerous. False alarms are imperceptible. For instance, no human operator review is required of gunshot detection data for indicating a gunshot event or a gunshot origination location. The lack of any human operator review is one of the factors that leads to the response time for the radar-based gunshot detection systems and methods being on the order of seconds, not minutes, which is significantly faster than acoustic-based systems. Angle accuracy of ±2.5° has been demonstrated along with ±20 m range accuracy in the current low power prototype. In some embodiments, the system is capable of ±1° angle accuracy and ±5 m range accuracy for shots that pass within 100 m of the system sensors.

An exemplary gunshot detection system of the present application includes a housing, a radar transmitter connected to the housing, a plurality of radar antennas connected to the housing, and a controller connected to the housing. The controller is operatively connected to the radar transmitter to cause the radar transmitter to generate radar transmission signals. The controller is configured to receive reflection data from the plurality of radar antennas. The controller is configured to determine a gunshot origination location of each bullet moving through a detection zone based on the reflection data.

An exemplary method of detecting a gunshot includes transmitting, by a radar transmitter, radar transmission signals; receiving, by a plurality of radar antennas, reflections of the radar transmission signals; generating, by the plurality of radar antennas, reflection data based on the reflections received; monitoring and recording, by a controller, the reflection data; determining, by the controller, a gunshot origination location for each bullet determined to be moving faster than a predetermined threshold based on the reflection data; and generating, by the controller, an indication of a gunshot event and the gunshot origination location on a display device.

### BRIEF DESCRIPTION OF THE DRAWINGS

FIG. 1 is a perspective view of a gunshot detection system according to embodiments of the present disclosure;

FIG. 2 is a top view of the gunshot detection system according to FIG. 1;

FIG. 3 is an illustration of an exemplary radar transmitter transmit waveform 110 according to embodiments of the present disclosure;

FIG. 4 is a perspective view of the gunshot detection system of FIG. 1 with an illustrated detection zone according to embodiments of the present disclosure;

FIG. 5 is a top view of the gunshot detection system and detection zone of FIG. 4;

FIG. 6 is an illustration of two adjacent radar antennas of the gunshot detection system according to FIG. 1 according to embodiments of the present disclosure;

FIG. 7 is an illustration of a circuit schematic of a gunshot detection system according to embodiments of the present disclosure;

FIG. 8 is a perspective view of a trailer mounted gunshot detection system according to embodiments of the present disclosure;

FIG. 9 is helmet-housed gunshot detection system according to embodiments of the present disclosure; and

FIG. 10 is an illustrative block diagram of a gunshot detection method according to embodiments of the present disclosure.

### DETAILED DESCRIPTION

For the purposes of the present disclosure, a “gunshot” should be interpreted to mean an event where a firearm is discharged to propel a bullet (or ballistic or projectile). A “gunshot origination location” should be interpreted to mean the location (or an area) where the firearm was discharged. The location could be determined as geographic coordinates. For example and without limitation, the gunshot origination location could be determined as latitude/longitude coordinates. Alternatively, the gunshot origination location could be determined by a controller and output to a display device (e.g. a computer, tablet, smartphone, or the like) as a pin on a map or a relative distance and heading from a device/system location.

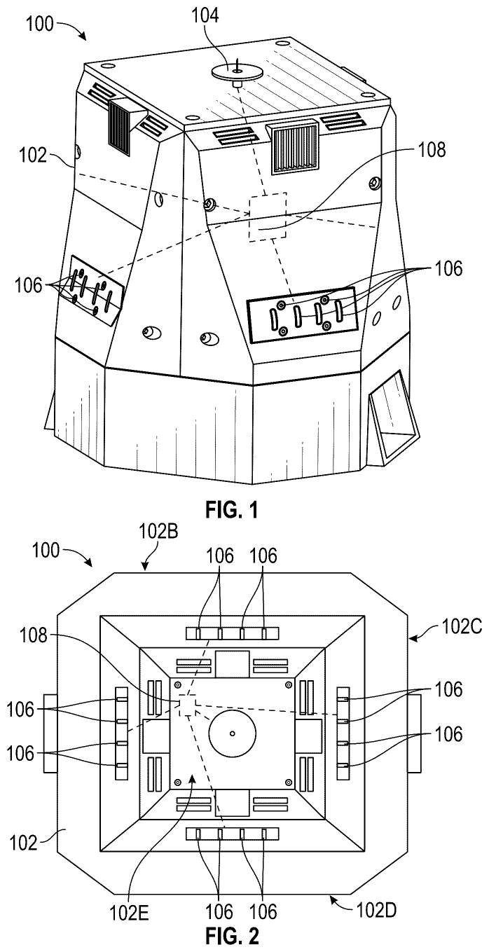

Referring to FIG. 1, an exemplary gunshot detection system 100 is shown in accordance with embodiments of the present disclosure. The system 100 includes a housing 102, a radar transmitter 104 connected to the housing 102 and a plurality of radar antennas 106 connected to the housing 102. The system 100 further includes a controller 108 connected to the housing 102 and operatively connected to the radar transmitter 104. The controller 108 is configured to receive radar reflection data generated by the plurality of radar antennas 106 based on reflections received by one or more of the antennas 106.

Referring to FIG. 2, which shows a top view of the gunshot detection system 100 of FIG. 1, there are four sets of four directional radar antennas 106 arranged on four sides 102A, 102B, 102C, 102D of the housing 102. This distribution of radar antennas 106 advantageously allows for a 360° detection range around the housing 102. Not all applications require a 360° detection range. It will be apparent to those of ordinary skill in the art that the antenna 106 distribution and housing 102 shape is configured to fit the desired detection area. For example, if the system 100 is to be arranged on a wall facing outwards there is no need for antennas 106 to be detecting areas facing the wall. In such scenarios the housing 102 can be configured to sit flush on the wall (or near the wall) and the antenna 106 distribution is arranged for 180° detection range facing away from the wall.

In the shown embodiment, there are sixteen radar antennas 106 distributed circumferentially around the housing 102 and one radar transmitter 104 arranged on a top side 102E of the housing 102. However, it should be understood that different embodiments having more or less radar transmitters 104 and radar antennas 106 are within the scope of the present disclosure. Further, the radar transmitter(s) 104 and radar antennas 106 do not necessarily need to be connected to the same housing 102. Rather, in some embodiments, one or more of the radar transmitter(s) 104 and radar antennas 106 are associated with two or more housings 102.

The controller 108 is configured to operate the radar antenna 104 to generate and transmit radar transmission signals in a variety of manners. In some embodiments, a transmit antenna of the radar transmitter 104 is configured as an omnidirectional, continuous transmit antenna. The continuous transmit of the radar transmitter 104 is different than conventional radar detection of large aerial objects (e.g. aircraft) that rely on discrete pulse radar transmissions.

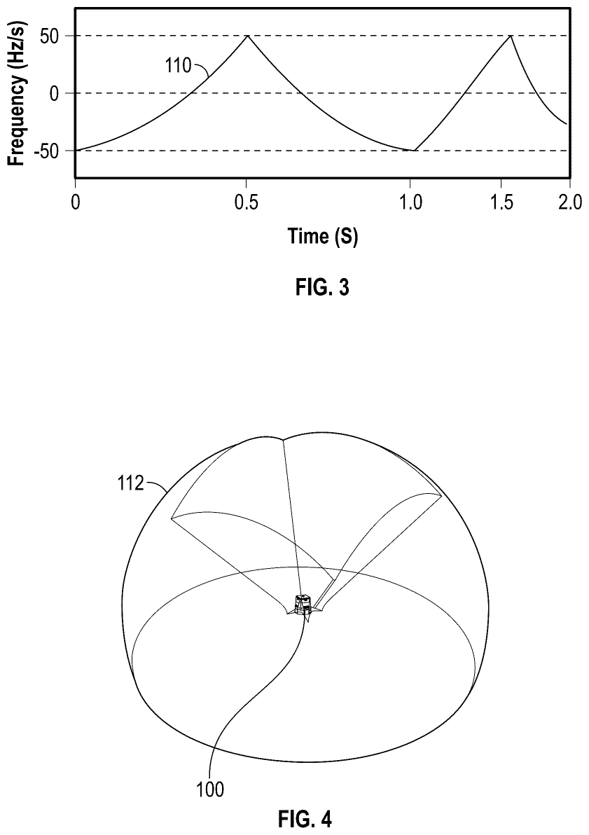

The shape of the radar transmission signal may be referred to as a waveform. Referring to FIG. 3, an illustration of an exemplary up/down chirp waveform 110 is shown in accordance with embodiments of the present disclosure. The waveform 110 shows an up/down chirp plotted with frequency (Hz/s) on the y-axis and time(s) on the x-axis. While the degree of the slope on the up portion of the waveform 110 is the same but opposite of the slope of the down portion of the waveform 110, in some embodiments the slopes degrees vary. In operation, this waveform 110 is repeated many times continuously and each up/down chirp may be referred to as a pulse. In some embodiments, the waveform 110 is a continuous linear up/down chirp. This up/down chirp waveform 110 facilitates transforming the measurement of range to an object detected by the antennas 106 to the measurement of a frequency when the echo is mixed with the transmitted waveform 110. The up/down chirp waveform also facilitates a very long pulse compared to the out and back distance thereby a large energy since Energy=Power×Duration. The transmission is preferably performed at a 100% duty cycle, which is distinctive from traditional radar systems that transmit at significantly lower duty cycles, e.g. ˜33% duty cycle or less. The up/down chirp waveform 110 also facilitates signal processing computations that are an order of magnitude lower than the bandwidth of the waveform 110 by mixing the transmit signal with the returning echoes. This also creates a problem in that clutter and signal can yield identical differential frequencies after the mixer. Since the bullet moves from pulse to pulse, and the clutter does not, the waveform selection allows for an average among pulses that can be computed and subtracted to leave exposed information about the speed and range of the bullet.

When in operation, the radar antennas 106 are configured to receive reflected radar signals (or echoes) from objects that were transmitted by the radar transmitter 104. The three-dimensional spatial area the antennas 106 are capable of effectively detecting the radar reflections from bullets may be referred to as the detection zone. It will be appreciated by those of ordinary skill in the art that the size and shape of the detection zone depends on a variety of factors, such as and without limitation: the power rating of the transmitter 104, antenna 106 location arrangement on the housing 102, the size and type of the antennas 106, other non-bullet objects in the environment (e.g. stationary objects or other obstacles), and the like. In some embodiments, the detection zone is 20 meters wide or in diameter (although detection zone does not need to be in the shape of a circle/sphere). However, the detection zone may be larger, e.g. 100 meters or 500 meters wide or in diameter.

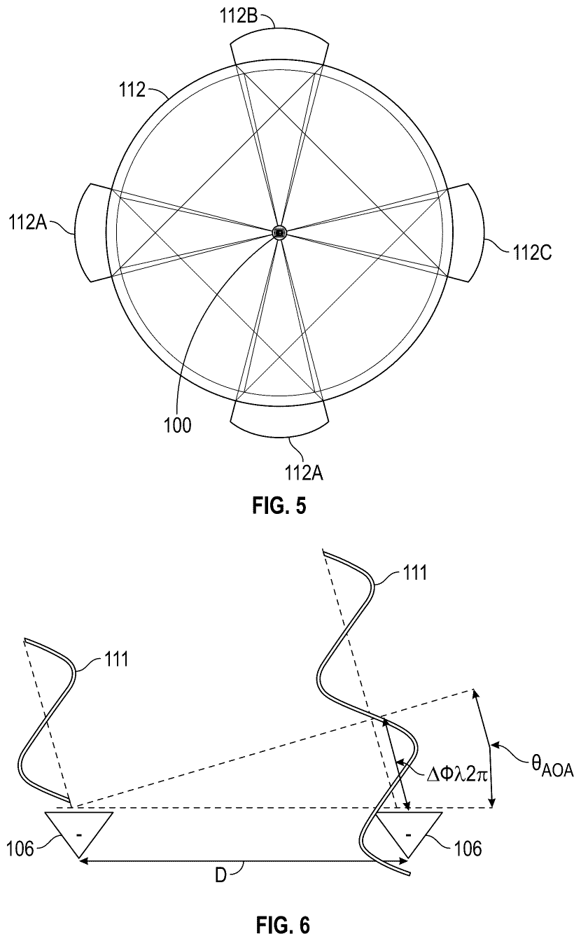

Referring to FIGS. 4 and 5, an exemplary detection zone 112 of the system 100 of FIG. 1 is shown according to embodiments of the present disclosure. In this embodiment, the antennas 106 are directional receive antennas that work in pairs, with each antenna 106 pair detecting over 90° horizontal angle detection area. The detection zone 112 includes several areas 112A, 112B, 112C, 112D of detection area overlap of antenna 106 pairs. As shown in FIG. 5, the first area overlap 112A corresponds to the detection overlap of the antenna 106 pairs arranged on the first side 102A of the housing 102, the second area overlap 112B corresponds to the detection overlap of the antenna 106 pairs arranged on the second side 102B of the housing, the third area overlap 112C corresponds to the detection overlap of the antenna 106 pairs arranged on the third side 102C of the housing 102, and the fourth area overlap 112D corresponds to the detection overlap of the antenna 106 pairs arranged on the fourth side 102D of the housing 102. The overlapping detection areas 112A-112D provide for robust reliability and, thus, increased confidence for controller 108 determinations based on reflected signals received from those areas by multiple antenna 106 pairs. However, overlapping detection areas 112A-112D are optional and not necessary for implementing radar-based gunshot detection systems and methods of the present disclosure.

During operation, the controller 108 is configured to collect and record the reflection data generated by the antennas 106 and perform a number of operations in order to determine gunshot event information, such as gunshot origination location of each bullet detected in the detection zone 112. One of the operations the controller 108 is configured to perform is clutter cancellation. In practice, clutter has been found to be on the order of 40 dB (a factor of 10,000) stronger than the bullet reflection signal. Clutter and signal are comingled at frequency offset (corresponding to range+Doppler). The ability to effectively cancel clutter is crucial to differentiating the detected small signal reflections from the bullet in the detection zone 112 from the large signal reflections of other objects. Clutter cancellation is at least in part achieved by the controller 108 being configured to average the collected reflection data of continuous reflected signals over time since the transmit waveform 110 is continuously transmitted at 100% duty cycle. When the reflection signal (or echo) is received, the reflection data is mixed or multiplied with the transmit waveform 110 for the computation of the average.

The controller 108 is configured to disregard clutter or noise received signals that are not determined as moving above a predetermined threshold for speed or velocity. Averaging over time is needed in order for the clutter echoes to become stable. Echoes from distant clutter (e.g. trees in the distance) arrive in patches from multiple pulse repetition intervals (PRI). In some embodiments, the controller 108 is configured to disregard or not include in the computational average one or more initial echoes received so that the clutter data received is stable. After that, a long term sliding average of recent echoes is used to estimate the clutter and then subtract or cancel the clutter. The long term average is on the order of ¼ to ½ of the coherent processing interval (CPI). A short term average may be, for example, three to five pulses of the transmitted waveform 110. A long term average is desirable for superior clutter suppression and facilitates detection of the bullet projectile(s) that is significantly smaller than clutter. This long term average is possible due to the relatively fast pulses and short CPI compared to conventional airborne and ground based radar arranged for detecting large objects. The predetermined threshold may be, for example and without limitation, objects moving at a speed greater than 50 meters/second. However, any predetermined threshold may be set by the manufacturer, administrator or user of the system 100.

The controller 108 is configured to determine the occurrence of “singleton” events and “doubleton” events. A singleton event is determined as having occurred when detection of reflection data by a single antenna 106 yields a range and velocity measurement of a detected bullet above a predefined threshold. A doubleton event is determined as having occurred when detections of reflection data by at least two antennas 106 (e.g. adjacent radar antennas 106) yield a similar range and velocity measurement of a detected bullet above a predefined threshold. In order to maximize overall detection performance, the threshold for determining a singleton event occurrence can be lowered when supported by another singleton event occurrence having similar detection statistics within an agreement threshold. False alarms are controlled by the similar range and velocity measurement threshold requirements for doubleton event determinations and by also requiring that the reflection data corresponding to at least M of N consecutive up/down chirps of the transmitted waveform 110 are above threshold on each of the singletons; where, in some embodiments, M and N are nominally M=3 and N=5. In some embodiments, the controller 108 is configured to provide higher confidence weight to doubleton event detected reflection data in comparison to singleton event detected reflection data. In some embodiments, the controller 108 is configured to indicate the gunshot event indication with gunshot origination location only when at least M of N doubleton events are detected (e.g. M=3 and N=5) to ensure high degree of confidence in the collected reflection data is indicative of a bullet detection. The controller 108 may be configured to have a less rigorous threshold for doubleton event than for a singleton event in order to generate the indication of the gunshot event and gunshot origination location. For example, the controller 108 may be set to require M=3 and N=5 for doubleton events and M=7 and N=9 for singleton events. The singleton event predetermined threshold can be lowered to offer increased sensitivity given that subsequent doubleton event determinations in at least two antennas 106 indicating the same range and velocity (or similar within a tolerance) as the singleton event in order to mitigate false alarms.

In some embodiments, the controller 108 may be configured to only generate the indication of the gunshot event and gunshot origination location after M of N singleton events are determined as having occurred above a predetermined singleton threshold and M of N doubleton events are determined as having occurred above predetermined doubleton threshold. The M of N requirement for the singleton events can be the same or different M of N for the doubleton events (e.g. M=3 and N=5). Put another way, the M of N number of singleton and/or doubleton events may be described as a certain number of the singleton or doubleton events determined as having occurred following a number of consecutive iterations of a waveform 110 transmitted by the transmitter 104. In some embodiments, the controller 108 is configured to proceed to performing trajectory analysis on each detected bullet for determining gunshot origination location only after the requisite singleton event determinations and doubleton event determinations have occurred. As a final check, the controller 108 may optionally be configured to perform a fit quality on a determined trajectory and only allow indications of a gunshot event and/or gunshot origination location to be outputted by the system when the determined trajectory satisfies a fit quality threshold (standard deviations of error per measurement).

The controller 108 is also configured to determine trajectory information of the detected bullet. In operation, the controller 108 determines information of each passing bullet, including range, radial speed, and azimuth based on the reflection data generated by the radar antennas 106, and based on that information, generates coordinates of the gunshot origination location through a trajectory solution process. The core of the trajectory solution process is based on the Newton-Raphson successive approximation method. The controller 108 may be configured to begin the approximation process with a guess (or predetermined value(s)) of the parameters that define the trajectory, check the fit of the guess, perturb the guess and observe the perturbations of the fit, and modify the guess, and then iterate until progress in fit diminishes to an acceptable error margin. Ideally, each component of the coordinate system should be relatively orthogonal to the others for the best sensitivity. The approaches to find a means for initializations of the various parameters was done in a way to be tiered and was both novel and creative.

Referring to FIG. 6, in some embodiments, the controller 108 is configured to determine angle of arrival of reflected signals 111 received at the radar antennas 106 by determining the phase difference between reflected signals 111. With the distance D between adjacent radar antennas 106 being known, the phase difference can be used to determine angle of arrival θ_{AOA} as follows:

$${θ}_{AOA} = {sin}^{- 1} ( \frac{Δϕ}{360 °} \frac{λ}{D} ) .$$

When the distance D between antenna 106 pairs is greater than λ/2 the measurements of angle of arrival θ_{AOA} can be ambiguous. Thus, the distance D between at least one or all of the antenna 106 pairs is preferably less than λ/2. Additionally, uniformly spaced antennas 106 having the same distance D between every antenna 106 results in poor stereo measurement because of greater ambiguities. Paired antenna 106 measurements have greater accuracy when the distance D between adjacent antennas 106, i.e. an antenna 106 pair, is smaller than the distance between one antenna 106 of an antenna 106 pair and the closest antenna 106 of another antenna 106 pair.

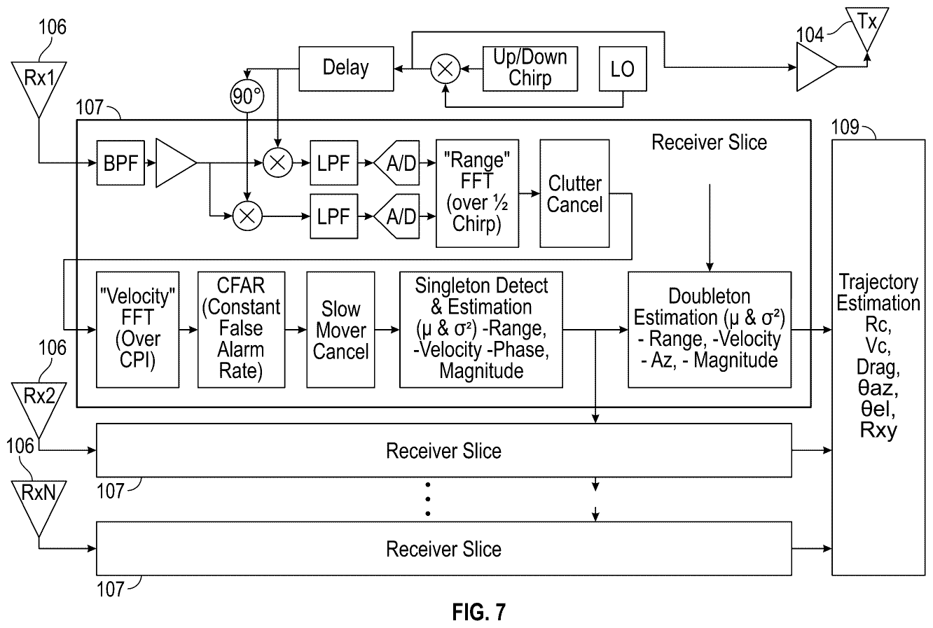

Referring to FIG. 7, an illustration of a circuit schematic of an exemplary gunshot detection system 100 according to the present disclosure is shown. The circuit schematic illustrates how the transmit waveform 110 transmitted by the transmitter 104 is de-ramped and mixed with the reflections received by the antennas 106 at each respective antenna slice 107. The after de-ramping by mixing, the detected reflections 111 at each antenna slice 107 is processed for each chirp of the transmitted waveform 110 with a “range” Fast Fourier Transform (FFT), de-cluttered with clutter cancelling, processed with a “velocity” FFT and checked with constant false alarm rate and slow-moving cancellation processes to discard errant data detected that does not correspond to a bullet. The reflection data is then moved through singleton and doubleton estimation processes to confirm that the data is either confirmed by the predefined M of N pulses and/or confirmed by doubleton event detections before being provided to the trajectory estimate module 109 for determination of the trajectory of each bullet by the controller 108.

In some embodiments, the system 100 is configured to be mounted to a stationary object such as a pole, building, lamp post, water tower, and the like. In some embodiments, the system 100 is configured to be mounted to a mobile platform. For example and without limitation, the system 100 is configured to be mounted to a helmet, vehicle, trailer, helicopter, aerial drone, and the like.

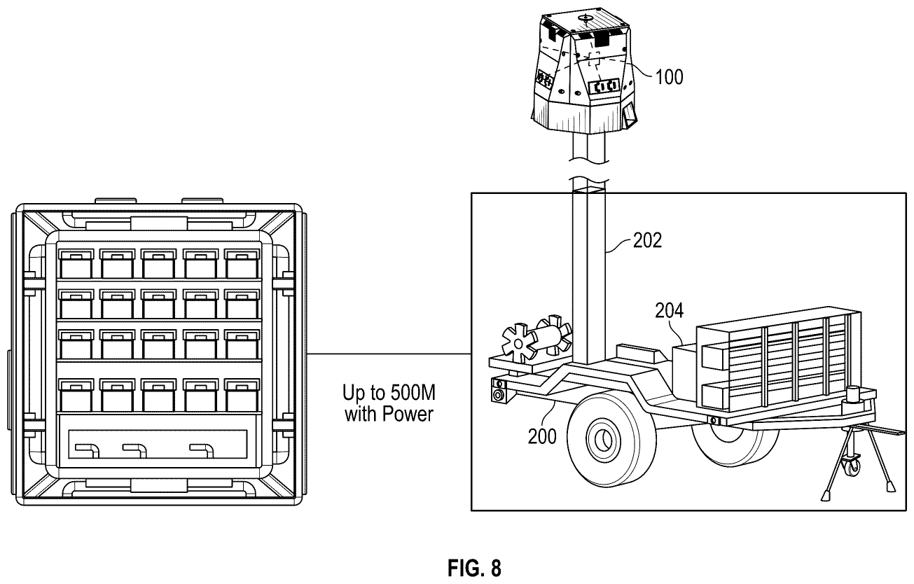

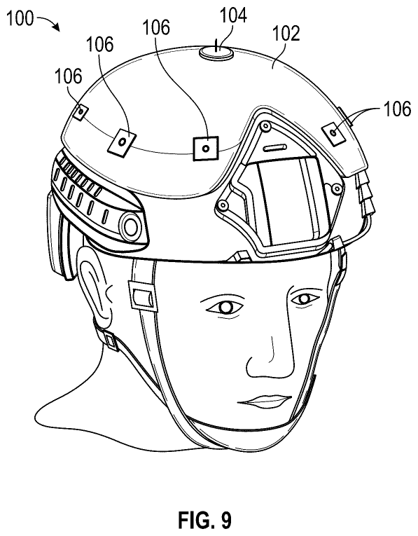

Referring to FIG. 8, a trailer 200 is shown according to embodiments of the present disclosure. The trailer 200 includes a main tower 202 with a system 100 mounted thereto. The trailer includes a generator 204 for powering the system 100. Referring to FIG. 9, a helmet housed gunshot detection system 100 is shown. The housing 102 in this embodiment is the framework of a helmet that is configured to be worn on the head of a user. When arranged for mobile field deployment, the power rating of the radar transmitter 104 is optimized to fit the field conditions. For example, when worn on a helmet of a person, the system 100 is configured to operate the radar transmitter 104 at a safe power rating and/or in a manner that is safe for the person wearing the system 100.

The controller 108 is configured with the necessary hardware and/or electronics to update in real-time the geographic location of the system 100 for correspondingly updating the coordinates recorded for detected bullets in the detection zone 112 when recording the reflection data indicative of the trajectory and gunshot origination location. In other words, when the system 100 is mobilized, the controller 108 will account for movements of the radar transmitter 104 and radar antennas 106 when recording reflection data determined as being associated with bullets moving within the detection zone 112. The controller 108 is configured to timestamp the gunshot origination location of each bullet detected moving within the detection zone 112 and/or timestamp the detected positions along the determined trajectory of each bullet moving through the detection zone 112. This recorded gunshot event information may be useful for law enforcement and/or judicial processes to determine the chronological sequence shots for determining a sequence of events. For example, the recorded gunshot event information may be useful for determining whether an accused perpetrator shot at police personnel first or whether the police personnel shot first, as well as also be useful for determining how many times shots were fired when shell casings and/or bullets are not recovered.

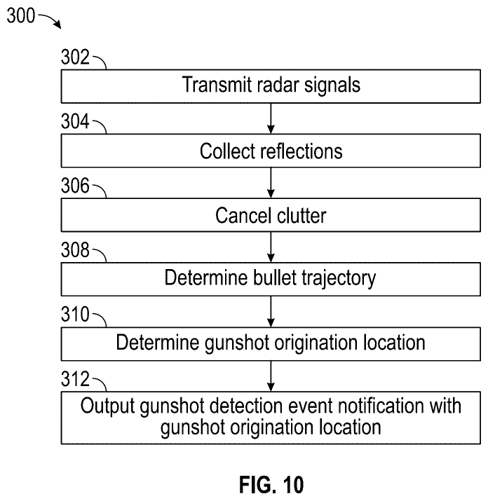

Referring to FIG. 10, an exemplary method 300 is illustrated according to embodiments of the present disclosure. The method 300 begins at block 302, where radar transmission signals are transmitted through one or more radar transmitters 104. At block 304, reflections of the radar transmission signals are collected by a plurality radar antennas 106, and the antennas 106 generate reflection data that is monitored and recorded by the controller 108. At block 306, the controller 108 cancels clutter and determines whether any bullets are moving within the detection zone 112. At block 308, the controller 108 determines a bullet trajectory for each bullet detected moving through the detection zone 112. At block 310, the controller 108 determines a gunshot origination location for each bullet detected moving through the detection zone 112 and any other relevant gunshot event information, such as time stamp, etc. At block 312, the controller 108 outputs a gunshot event notification with a gunshot origination location for each bullet detected and any other relevant gunshot event information. The gunshot event notification is outputted by the controller 108 to a display device without any human review or input required prior to the output and display of the gunshot event indication.

Advantageously, the systems and methods of the present application can be employed in school/university campuses, high-profile buildings, public sport/entertainment arenas, public open spaces, and the like. In some embodiments, the system may include a standalone housing with transmitter and antenna array. In some embodiments, the system may include a plurality of housings each having their own transmitter and antenna array to cover a large area with multiple detection zones.

In some embodiments, the architecture of the system 100 includes a Number Controlled Oscillator (NCO) for the generation of a precise and repeatable up/down chirp waveform 112. The NCO feeds a mixer to generate the transmit waveform 112. A copy of the transmit waveform 112 is leveraged to mix received signals and results in a narrow band (1s of MHz bandwidth) signal that is an order of magnitude less than the occupied RF bandwidth and correspondingly an order of magnitude easier to digitize and process.

The systems of the present disclosure may be portable units that are powered by a local power source, such as a battery and/or a solar panel. In some embodiments, the system includes a power connection for connection to an electrical grid.

Advantageously, the systems and methods of the present disclosure provide improved gunshot detection technology that provide fast detection (e.g. in some embodiments, less than 10 seconds response times or in some embodiments, less than 2 seconds response times), reduced false alarms (or in some embodiments, 0% false alarm rate), active background clutter reduction filters, accurate gunshot origination location (e.g. for evidence retrieval), small form factor (re-deployable sensors to highest activity/threat areas).

The system, computers, servers, devices and the like described herein may be any computer-based device having the necessary electronics, computer processing power, interfaces, memory, hardware, software, firmware, logic/state machines, databases, microprocessors, communication links, displays or other visual or audio user interfaces, printing devices, and any other input/output interfaces, to provide the functions or achieve the results described herein. Computers or computer-based devices described herein may include any number of computing devices capable of performing the functions described herein, including but not limited to: desktop computers, tablets, laptop computers, smartphones, smart TVs, and the like.

Although features of the present disclosure have been described in connection with different embodiments for simplicity, one of ordinary skill in the art should readily understand that various features may be applicable to, and readily incorporated, into other embodiments and still be within the scope of the present disclosure.

As will be recognized by those of ordinary skill in the art, numerous changes and modifications may be made to the above-described embodiments of the present disclosure without departing from the spirit of the invention. For example, embodiments having more or less radar transmitters or radar antennas as shown or described is fully within the scope of the present disclosure. Accordingly, the particular embodiments described in this specification are to be taken as merely illustrative and not limiting.

What is claimed is:

1. A gunshot detection system comprising:
a housing;
a radar transmitter connected to the housing;
a plurality of radar antennas connected to the housing; and
a controller connected to the housing;
wherein the controller is operatively connected to the radar transmitter to cause the radar transmitter to generate radar transmission signals;
wherein the controller is configured to receive reflection data from the plurality of radar antennas; and
wherein the controller is configured to determine a gunshot origination location of each bullet moving through a detection zone based on the reflection data.

2. The gunshot detection system according to claim 1, wherein the detection zone includes at least one area of detection overlap by two or more pairs of the plurality of radar antennas.

3. The gunshot detection system according to claim 1, wherein the detection zone includes a plurality of areas of detection overlap by a plurality of pairs of the plurality of radar antennas.

4. The gunshot detection system according to claim 1, wherein the controller is configured to generate an indication of the determined gunshot origination location only after the controller determines that at least a certain number of singleton events occurred corresponding to a number of consecutive iterations of a waveform transmitted by the radar transmitter resulting in at least a certain number of doubleton events occurred corresponding to the number of consecutive iterations of the waveform transmitted by the radar transmitter, each of the singleton events constituting reflection data detected by a single radar antenna of the plurality of antennas indicating a range and velocity measurement of each bullet moving through the detection zone being within a first predetermined threshold and each of the doubleton events constituting reflection data detected by at least two radar antennas of the plurality of antennas each confirming the range and velocity measurement of each bullet moving through the detection zone being within a second predetermined threshold.

5. The gunshot detection system according to claim 4, wherein the controller is configured to determine a trajectory for each bullet moving through the detection zone only when the controller determines the reflection data for each respective bullet results in the controller determining the at least a certain number of singleton events occurred corresponding to the number of consecutive iterations of the waveform transmitted by the radar transmitter and resulting in the at least certain number of doubleton events occurred corresponding to the number of consecutive iterations of the waveform transmitted by the radar transmitter.

6. The gunshot detection system according to claim 1, wherein the certain number of singleton events is three (M=3) and the number of consecutive iterations of the waveform transmitted by the radar transmitter is five (N=5).

7. The gunshot detection system according to claim 1, wherein the radar transmitter is configured to transmit the radar transmission signals omnidirectionally.

8. The gunshot detection system according to claim 1, wherein the plurality of radar antennas are distributed circumferentially about the housing to allow for 360° radar signal collection by the controller.

9. The gunshot detection system according to claim 1, wherein the plurality of receiving radar antennas are directional antennas.

10. The gunshot detection system according to claim 1, wherein controller is configured to cause the radar transmitter to continuously generate the radar transmission signals.

11. The gunshot detection system according to claim 1, wherein the housing is in the form of a helmet and configured to be worn on a head of a user.

12. The gunshot detection system according to claim 1, wherein the controller is configured to cancel clutter noise when determining the presence of each bullet in the detection zone, and wherein the cancelling of the clutter noise includes averaging the reflection data over time.

13. The gunshot detection system according to claim 1, wherein the controller is configured to output the gunshot origination location to a display device.

14. The gunshot detection system according to claim 1, further comprising a number controlled oscillator, and wherein the controller is configured to operate the radar transmitter to generate the radar transmission signals based on a feed from the number controlled oscillator.

15. The gunshot detection system according to claim 1, wherein the controller is configured to record a timestamp for the gunshot origination location for each bullet detected moving through the detection zone.

16. A method of detecting a gunshot comprising:
transmitting, by a radar transmitter, radar transmission signals;
receiving, by a plurality of radar antennas, reflections of the radar transmission signals;
generating, by the plurality of radar antennas, reflection data based on the reflections received;
monitoring and recording, by a controller, the reflection data;
determining, by the controller, a gunshot origination location for each bullet determined to be moving faster than a predetermined threshold based on the reflection data; and
generating, by the controller, an indication of a gunshot event and the gunshot origination location on a display device.

17. The method according to claim 16, wherein the transmitting by the radar transmitter occurs continuously and the receiving by the radar antennas occurs continuously simultaneously with the transmitting by the radar transmitter.

18. The method according to claim 16, wherein the generating the indication of a gunshot event and the gunshot origination location by the controller occurs in less than one seconds after the monitoring and recording of the reflection data.

19. The method according to claim 16, further comprising generating, by the controller, a timestamp for the reflection data recorded.

20. The method according to claim 16, wherein the generating the indication of a gunshot event and the gunshot origination location by the controller occurs without human operator review of the reflection data.
